(19) United States
(12) Patent Application Publication
(10) Pub. No.: US 2023/0359250 A1
(43) Pub. Date: Nov. 9, 2023

(54) ELECTRONIC DEVICE

(71) Applicant: WiBASE Industrial Solutions Inc., Taipei City (TW)

(72) Inventor: Shao Ping Shih, Taipei City (TW)

(73) Assignee: WiBASE Industrial Solutions Inc., Taipei City (TW)

(21) Appl. No.: 17/878,937

(22) Filed: Aug. 2, 2022

(30) Foreign Application Priority Data
May 9, 2022 (TW) 111117361

(51) Int. Cl. G06F 1/16; H01Q 23/00; H01Q 1/22

(52) U.S. Cl. CPC G06F 1/1658; G06F 1/1698; H01Q 23/00; H01Q 1/2266

(57) ABSTRACT

An electronic device includes an antenna, an object, a metal fixing member, and a sensor chip. The object and the metal fixing member are disposed beside the antenna, and the object is fixed by the metal fixing member. The sensor chip for detecting is electrically connected to the metal fixing member.

### CROSS-REFERENCE TO RELATED APPLICATION

This application claims the priority benefit of Taiwan application serial no. 111117361, filed on May 9, 2022. The entirety of the above-mentioned patent application is hereby incorporated by reference herein and made a part of this specification.

### BACKGROUND

### Technical Field

The disclosure relates to an electronic device, and in particular to an electronic device having an antenna.

### Description of Related Art

If a wireless electronic device is operated close to the human body, the transmit power of the antenna when used close to the human body must comply with regulations to avoid affecting human health. There are two ways to bring the transmit power of the antenna into compliance with regulations. One is to directly reduce the transmit power of the antenna to below regulatory requirements in order to comply with regulations, but this will affect the quality of reception when not close to human body.

The other is to set up a sensing device on the electronic device to sense whether the human body is close to the sensing device. When the user is detected to be close, the transmit power of the antenna is reduced to comply with regulations. There are two main ways to do this. One way is to set up a dedicated sensor pad on the product near the antenna. However, the dedicated sensor pad takes up a certain amount of space. The other method is to integrate the sensor pad with the antenna, and the antenna itself has the function of sensor pad. This method can reduce the size, but need to consider the characteristics of the antenna, so the antenna design is more complex.

### SUMMARY

The disclosure provides an electronic device which may sense the approach of a human body and modulate transmit power of an antenna without using additional sensor pads and without modifying a structure of the antenna.

An electronic device of the disclosure includes an antenna, an object, a metal fixing member, and a sensor chip. The object is disposed beside the antenna. The metal fixing member is disposed beside the antenna, and the object is fixed by the metal fixing member. The sensor chip for detecting is electrically connected to the metal fixing member.

In an embodiment of the disclosure, the metal fixing member includes a screw, a nut, a rivet, a clamp or a fastener.

In an embodiment of the disclosure, the object includes an antenna bracket, the antenna is disposed on the antenna bracket, and the antenna bracket is fixed by the metal fixing member.

In an embodiment of the disclosure, the electronic device further includes a casing. The antenna, the object, and the metal fixing member are located in the casing, and the metal fixing member fixes the object to the casing.

In an embodiment of the disclosure, the electronic device further includes another metal fixing members, wherein the metal fixing member and the another metal fixing members are located on at least two opposite sides of the antenna.

In an embodiment of the disclosure, a diameter of the metal fixing member is between 5 mm and 8 mm.

In an embodiment of the disclosure, the electronic device further includes a radio frequency transceiver and a controller. The radio frequency transceiver is electrically connected to the antenna. The controller is electrically connected to the radio frequency transceiver and the sensor chip. In response to the sensor chip detects that the metal fixing member is approached by a human body, the sensor chip sends a signal to the controller, then the controller reduces a transmit power of the radio frequency transceiver to the antenna.

In an embodiment of the disclosure, the electronic device is a tablet computer, a cell phone or a laptop, and the electronic device includes a screen and a bezel region surrounding the screen, and the antenna and the metal fixing member are located in the bezel region.

In an embodiment of the disclosure, a distance between the metal fixing member and the antenna is between 3 mm and 10 mm.

In an embodiment of the disclosure, the electronic device further includes another metal fixing members, wherein the metal fixing member and the another metal fixing members are of the same or different types.

An electronic device includes an antenna, an object and a metal fixing member for sensing. The object is disposed beside the antenna. The metal fixing member for sensing is disposed beside the antenna, wherein the object is fixed by the metal fixing member.

In an embodiment of the disclosure, the metal fixing member comprises a screw, a nut, a rivet, a clamp or a fastener.

In an embodiment of the disclosure, the object comprises an antenna bracket, the antenna is disposed on the antenna bracket, and the antenna bracket is fixed by the metal fixing member.

In an embodiment of the disclosure, the electronic device further includes a casing, wherein the antenna, the object, and the metal fixing member are located in the casing, and the metal fixing member fixes the object to the casing.

In an embodiment of the disclosure, the electronic device further includes another metal fixing members, wherein the metal fixing member and the another metal fixing members are located on two opposite sides of the antenna.

In an embodiment of the disclosure, a diameter of the metal fixing member is between 5 mm and 8 mm.

In an embodiment of the disclosure, the electronic device further includes a sensor chip electrically connected to the metal fixing member; a radio frequency transceiver electrically connected to the antenna; and a controller electrically connected to the radio frequency transceiver and the sensor chip, wherein in response to the metal fixing member senses a human body is approached, the sensor chip sends a signal to the controller, then the controller reduces a transmit power of the radio frequency transceiver to the antenna.

In an embodiment of the disclosure, the electronic device is a tablet computer, a cell phone or a laptop, and the electronic device comprises a screen and a bezel region surrounding the screen, and the antenna and the metal fixing member are located in the bezel region.

In an embodiment of the disclosure, a distance between the metal fixing member and the antenna is between 3 mm and 10 mm.

In an embodiment of the disclosure, the electronic device further includes another metal fixing members, wherein the metal fixing member and the another metal fixing members are of the same or different types.

Based on the above, the electronic device of the disclosure uses the metal fixing member originally used to fix the object as the sensor pad of the antenna. The metal fixing member is electrically connected to the sensor chip, so that the sensor chip may detect whether the human body is approaching by the metal fixing member. Therefore, the electronic device of the disclosure does not need to use a dedicated sensor pad to sense whether the human body is approaching, which may save cost and free up space inside the electronic device for other elements to be placed, and does not need to modify the structure of the antenna, which is quite simple convenient.

To make the aforementioned more comprehensible, several accompanied with drawings are described in detail as follows.

### BRIEF DESCRIPTION OF THE DRAWING

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an electronic device according to an embodiment of the disclosure.

FIG. 2 is an enlarged top diagram of the interior of a bezel region of the electronic device of FIG. 1.

FIG. 3 is an enlarged three-dimensional diagram of the interior of the bezel region of the electronic device of FIG. 1.

FIG. 4 is a block diagram of some elements of the electronic device of FIG. 1.

FIG. 5 shows a relationship between a combination of an antenna and a metal fixing member of the electronic device of FIG. 1 as well as frequency without the metal fixing member beside the antenna and S11.

### DESCRIPTION OF THE EMBODIMENTS

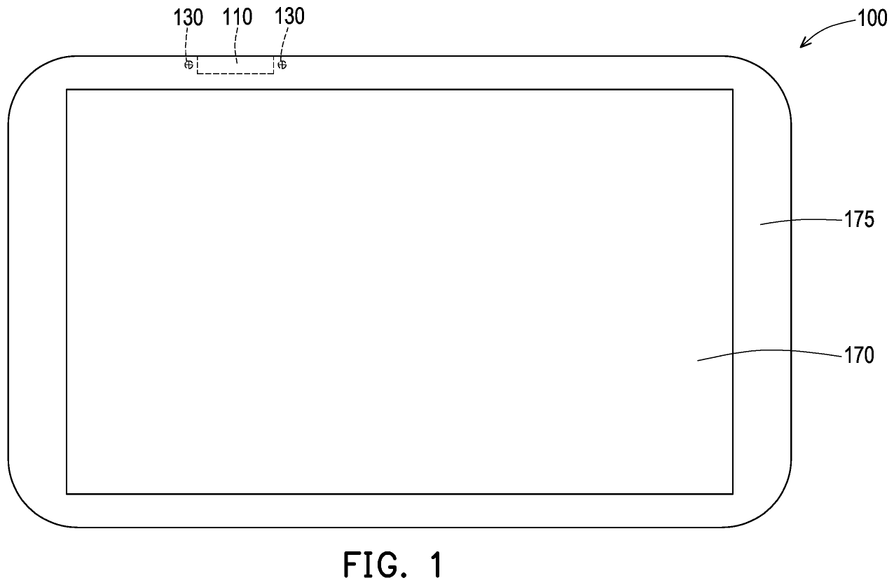

FIG. 1 is a schematic diagram of an electronic device according to an embodiment of the disclosure. Referring to FIG. 1, an electronic device 100 according to this embodiment is a tablet computer for example, but the type of the electronic device 100 is not limited thereto. According to other embodiments, the electronic device 100 may also be a cell phone or a laptop.

According to this embodiment, the electronic device 100 includes a screen 170, a bezel region 175 surrounding the screen 170, an antenna 110 located in the bezel region 175, and a metal fixing member 130. The antenna 110 and the metal fixing member 130 are covered by a casing of the bezel region 170, and are indicated by dashed lines. According to this embodiment, the antenna 110 and the metal fixing member 130 are disposed in the bezel region 175 to avoid interference by the metal in the screen 170.

The electronic device 100 according to this embodiment may use a human body sensing mechanism to detect whether a user is approaching, and when the user is approaching, the electronic device 100 reduces transmit power of the antenna, so that the transmit power of the antenna may comply with regulations. In addition, the electronic device 100 according to this embodiment sense the approach of the user without using additional sensor pads and without modifying the design of the antenna to achieve the above-mentioned effects, as explained below.

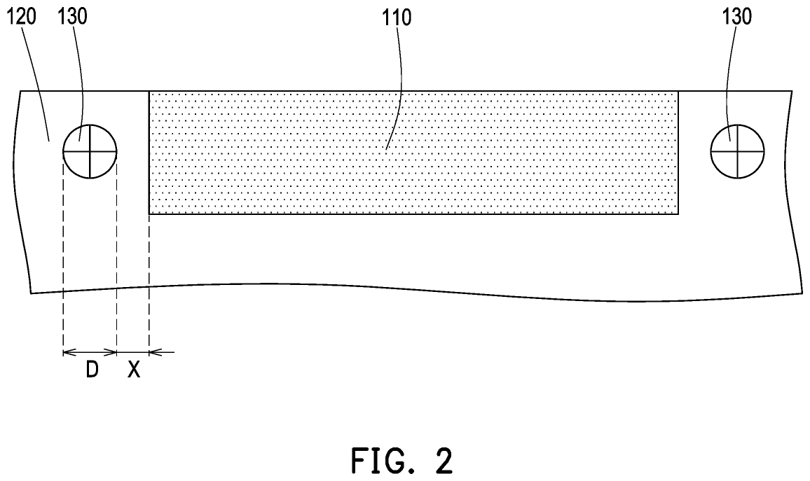

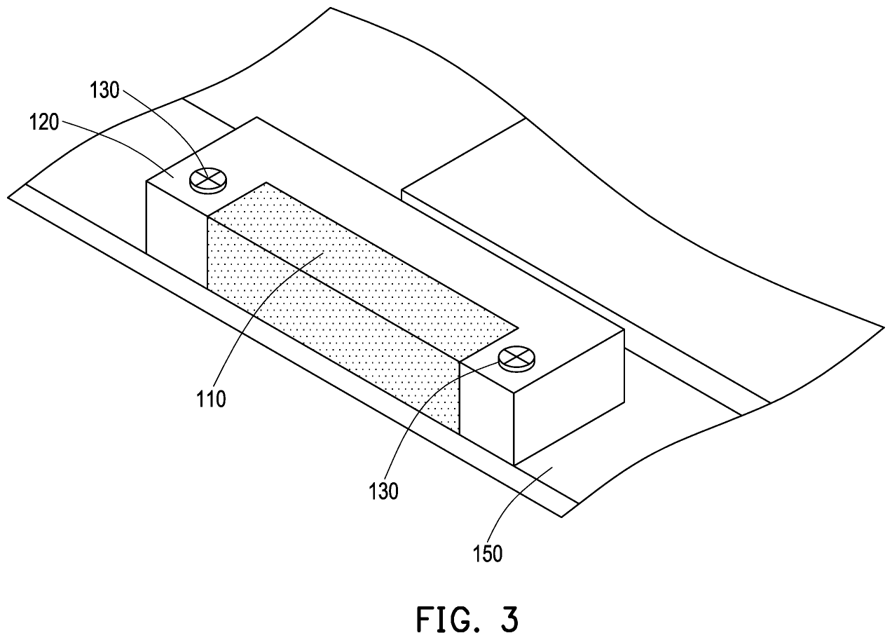

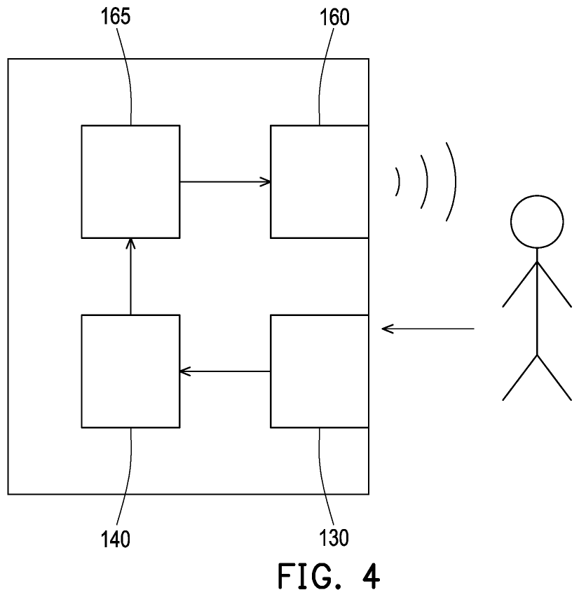

FIG. 2 is an enlarged top diagram of the interior of the bezel region of the electronic device of FIG. 1. FIG. 3 is an enlarged three-dimensional diagram of the interior of the bezel region of the electronic device of FIG. 1. FIG. 4 is a block diagram of some elements of the electronic device of FIG. 1. Referring to FIG. 2 to FIG. 4, the electronic device 100 according to this embodiment further includes an object 120 and a sensor chip 140 (FIG. 4). The object 120 and the metal fixing member 130 are disposed beside the antenna 110, and the object 120 is fixed by the metal fixing member 130. As shown in FIG. 4, the metal fixing member 130 is electrically connected to the sensor chip 140.

As shown in FIG. 3, according to this embodiment, the object 120 includes, for example, an antenna bracket, and the antenna 110 is disposed on the antenna bracket. The material of the antenna bracket is plastic, for example, but the material of the antenna bracket is not limited thereto, as long as it is insulating.

The electronic device 100 according to this embodiment further includes a casing 150 (FIG. 3), the antenna 110. The object 120 and the metal fixing member 130 are located in the casing 150, and the metal fixing member 130 is used to fix the object 120 to the casing 150.

Of course, the type of the object 120 is not limited thereto. According to other embodiments, the object 120 may also be other existing structures close to the antenna 110, and the object 120 may also be an electronic element. The metal fixing member 130 is used to fix the existing object 120 and is insulated from the object 120.

In addition, according to this embodiment, the metal fixing member 130 is a screw for example, and the metal fixing member 130 may be locked on a screw holder (not shown) fixed on the casing 150 to press the object 120 against the metal fixing member 130 between the casing 150. Of course, the types of the metal fixing member 130 are not limited thereto. According to other embodiments, the metal fixing member 130 may also include a nut, a rivet, a clamp or a fastener.

It should be noted that, according to this embodiment, a number of the metal fixing members 130 is multiple, e.g., two, and are located on opposite sides of the antenna 110. More specifically, two metal fixing members 130 are located beside two short sides of the antenna 110.

According to other embodiments, the two metal fixing members 130 may also be located beside two long sides of the antenna 110. Alternatively, the number of the metal fixing members 130 may be more than two, and are disposed along an edge of the antenna 110.

In addition, according to this embodiment, the types of the two metal fixing members 130 are the same, and both are screws. But according to other embodiments, the types of the metal fixing members 130 may also be different. For example, the metal fixing members 130 may be at least two of the screw, nut, rivet, clamp and fastener. As long as the metal fixing member 130 is close to the antenna 110 and is electrically connected to the sensor chip 140, it may be used as a sensor pad or a sensing radiator for sensing whether the human body is approaching.

It is known that the sensor pad which is specially used to sense the approach of the human body needs to have a certain size. For example, a length of a known sensor pad is, for example, 11 mm and a width is, for example, 11 mm. A distance that can be sensed by such a sensor pad is, for example, 25 mm.

As shown in FIG. 2, according to this embodiment, a diameter D (FIG. 2) of the metal fixing member 130 is between 5 mm and 8 mm, e.g., 5 mm, while having a smaller size. For example, the diameter D of the metal fixing member 130 (screw) is 5 mm, and the metal fixing member has been tested to have a sensing distance of up to 30 mm with good performance.

In addition, according to this embodiment, a distance X (FIG. 2) between each of the metal fixing members 130 and the antenna 110 is between 3 mm and 10 mm, e.g., 5 mm. The distance X between the metal fixing member 130 and the antenna 110 in a range described above may better reflect the approach of the human body to the antenna 110. Of course, the distance X between the metal fixing member 130 and the antenna 110 is not limited by the above.

According to this embodiment, the electronic device 100 uses the metal fixing member 130 close to the antenna 110 as a sensor pad or a sensing radiator for sensing whether the human body is approaching. The metal fixing member 130 is electrically connected to the sensor chip 140 to transmit a sensed signal to the sensor chip 140 (FIG. 4). Therefore, the sensor chip 140 may detect whether the human body is approaching by the metal fixing member 130.

In other words, the metal fixing member 130 according to this embodiment has two functions, the first is to fix the object 120, and the second is to be used as a sensor pad or a sensing radiator to sense the approach of the human body.

Since the electronic device 100 uses the metal fixing member 130 originally used to fix the object 120 as the sensor pad or sensing radiator to sense the sensing radiator of the human body, the electronic device 100 does not need additional sensor pad, which may effectively save cost and free up space for placing other elements where the sensor pad was originally to be disposed.

In addition, as shown in FIG. 4, according to this embodiment, the electronic device 100 further includes a radio frequency transceiver 160 and a controller 165. The radio frequency transceiver 160 is electrically connected to the antenna 110. The controller 165 is electrically connected to the radio frequency transceiver 160 and the sensor chip 140.

Thus, when the human body approaches the metal fixing member 130 located beside the antenna 110 (FIG. 2), the sensor chip 140 detects a change in capacitance or resistance through the metal fixing member 130 to determine the approach of the human body. The sensor chip 140 transmits a signal to the controller 165, and the controller 165 reduces the transmit power of the antenna of the radio frequency transceiver 160 to the antenna 110 according to the received signal, so as to reduce the impact of the transmit power of the antenna on the human body and to comply with regulations.

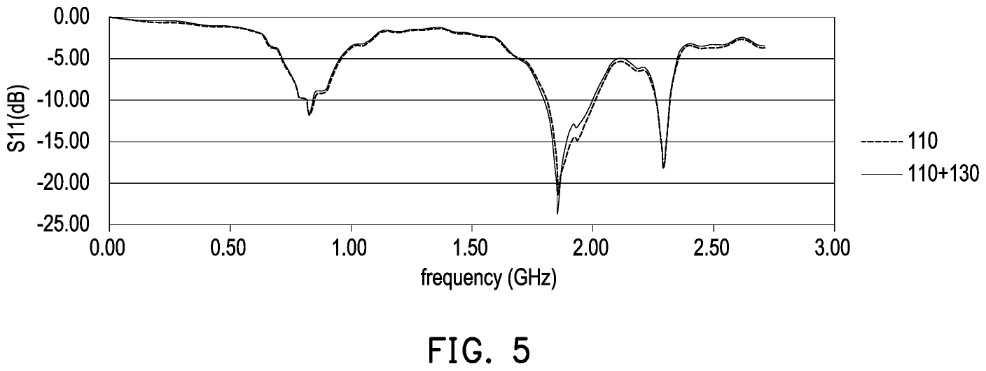

FIG. 5 shows a relationship between a combination of an antenna and a metal fixing member of the electronic device of FIG. 1 as well as frequency without the metal fixing member beside the antenna and S11. Referring to FIG. 5, a simulation result for the combination of the antenna 110 and the metal fixing member 130 of the electronic device 100 of FIG. 1 is shown as a solid line, and a simulation result for the antenna 110 without the metal fixing member 130 is shown as a dashed line. As can be seen in FIG. 5, the solid line and the dashed line are quite close to each other, which means that the design of the metal fixing member 130 beside the antenna 110 does not affect the return loss characteristics of the antenna 110 itself, but can have a good performance.

To sum up, the electronic device of the disclosure uses the metal fixing member originally used to fix the object as the sensor pad of the antenna. The metal fixing member is electrically connected to the sensor chip, so that the sensor chip may detect whether the human body is approaching by the metal fixing member. Therefore, the electronic device of the disclosure does not need to use a dedicated sensor pad to sense whether the human body is approaching, which may save cost and free up space inside the electronic device for other elements to be placed, and does not need to modify the structure of the antenna, which is quite simple convenient.

It will be apparent to those skilled in the art that various modifications and variations can be made to the disclosed without departing from the scope or spirit of the disclosure. In view of the foregoing, it is intended that the disclosure covers modifications and variations provided that they fall within the scope of the following claims and their equivalents.

What is claimed is:

1. An electronic device comprising:
an antenna;
an object disposed beside the antenna;
a metal fixing member disposed beside the antenna, wherein the object is fixed by the metal fixing member; and
a sensor chip for detecting electrically connected to the metal fixing member.

2. The electronic device according to claim 1, wherein the metal fixing member comprises a screw, a nut, a rivet, a clamp or a fastener.

3. The electronic device according to claim 1, wherein the object comprises an antenna bracket, the antenna is disposed on the antenna bracket, and the antenna bracket is fixed by the metal fixing member.

4. The electronic device according to claim 1 further comprising a casing, wherein the antenna, the object, and the metal fixing member are located in the casing, and the metal fixing member fixes the object to the casing.

5. The electronic device according to claim 1, further comprising another metal fixing members, wherein the metal fixing member and the another metal fixing members are located on two opposite sides of the antenna.

6. The electronic device according to claim 1, wherein a diameter of the metal fixing member is between 5 mm and 8 mm.

7. The electronic device according to claim 1 further comprising:
a radio frequency transceiver electrically connected to the antenna; and
a controller electrically connected to the radio frequency transceiver and the sensor chip, wherein in response to the sensor chip detects that the metal fixing member is approached by a human body, the sensor chip sends a signal to the controller, then the controller reduces a transmit power of the radio frequency transceiver to the antenna.

8. The electronic device according to claim 1, wherein the electronic device is a tablet computer, a cell phone or a laptop, and the electronic device comprises a screen and a bezel region surrounding the screen, and the antenna and the metal fixing member are located in the bezel region.

9. The electronic device according to claim 1, wherein a distance between the metal fixing member and the antenna is between 3 mm and 10 mm.

10. The electronic device according to claim 1, further comprising another metal fixing members, wherein the metal fixing member and the another metal fixing members are of the same or different types.

11. An electronic device comprising:
an antenna;
an object disposed beside the antenna; and
a metal fixing member for sensing disposed beside the antenna, wherein the object is fixed by the metal fixing member.

12. The electronic device according to claim 11, wherein the metal fixing member comprises a screw, a nut, a rivet, a clamp or a fastener.

13. The electronic device according to claim 11, wherein the object comprises an antenna bracket, the antenna is disposed on the antenna bracket, and the antenna bracket is fixed by the metal fixing member.

14. The electronic device according to claim 11 further comprising a casing, wherein the antenna, the object, and the metal fixing member are located in the casing, and the metal fixing member fixes the object to the casing.

15. The electronic device according to claim 11, further comprising another metal fixing members, wherein the metal fixing member and the another metal fixing members are located on two opposite sides of the antenna.

16. The electronic device according to claim 11, wherein a diameter of the metal fixing member is between 5 mm and 8 mm.

17. The electronic device according to claim 11 further comprising:
a sensor chip electrically connected to the metal fixing member;
a radio frequency transceiver electrically connected to the antenna; and
a controller electrically connected to the radio frequency transceiver and the sensor chip, wherein in response to the metal fixing member senses a human body is approached, the sensor chip sends a signal to the controller, then the controller reduces a transmit power of the radio frequency transceiver to the antenna.

18. The electronic device according to claim 11, wherein the electronic device is a tablet computer, a cell phone or a laptop, and the electronic device comprises a screen and a bezel region surrounding the screen, and the antenna and the metal fixing member are located in the bezel region.

19. The electronic device according to claim 11, wherein a distance between the metal fixing member and the antenna is between 3 mm and 10 mm.

20. The electronic device according to claim 11, further comprising another metal fixing members, wherein the metal fixing member and the another metal fixing members are of the same or different types.
